(19) United States
(12) Patent Application Publication
(10) Pub. No.: US 2007/0220162 A1
(43) Pub. Date: Sep. 20, 2007

(54) Media processing abstraction model

(75) Inventors: Danny Levin, Redmond, WA (US); Warren Berkley, Mill Creek, WA (US); Wei Zhong, Issaquah, WA (US); Tim Moore, Redmond, WA (US); Michael VanBuskirk, Redmond, WA (US); Yiu-Ming Leung, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/378,163

(22) Filed: Mar. 17, 2006

(51) Int. Cl. G06F 15/16; G06F 15/173

(52) U.S. Cl. 709/231; 709/238; 709/244

(57) ABSTRACT

Techniques are described for providing media services. A media processor receives one or more input media streams and provides an output media stream to one or more endpoints. A media controller issues commands to the media processor for controlling the media streams. The media controller and the media processor communicate in accordance with a defined protocol allowing for independent control of each of the media streams.

### BACKGROUND

A media application server may be used in connection with serving media for a variety of different purposes including, for example, audio and/or video conferencing. The media application server may reside on a server system in connection with servicing various media requests in accordance with the particular media and associated operations that may be performed by the media application server. Each media application server generally includes code for performing the particular application logic as well as code for performing media processing operations that may also be performed more generally by other media application servers. In other words, media application servers may perform a common set of media processing operations independent of the particular application logic. In some existing systems, the code for the common set of operations performed by a media application server may be included in each media application server. One drawback with the foregoing is that this may be inefficient due to possibly recoding a same portion of code for different media application servers. Additionally, including the same code portions for common operations in the different media application servers may lead to problems with code maintenance due to the duplicate copies of code.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are described for media processing. A media processor receives one or more input media streams and provides an output media stream to one or more endpoints. A media controller issues commands to the media processor for controlling the media streams. The media controller and the media processor communicate in accordance with a defined protocol allowing for independent control of each of the media streams.

### DESCRIPTION OF THE DRAWINGS

Features and advantages of the present invention will become more apparent from the following detailed description of exemplary embodiments thereof taken in conjunction with the accompanying drawings in which:

FIG. 1 is an example of an embodiment illustrating an environment that may be utilized in connection with the techniques described herein;

FIG. 2 is an example of components that may be included in an embodiment of a server computer for use in connection with performing the techniques described herein;

FIG. 3 is an example illustrating in more detail components of one or more media server applications;

FIG. 4 is an example of various structures and descriptors that may be included in an embodiment in connection with the techniques describe herein for media processing;

FIG. 5 is a flowchart of processing steps that may be performed in an embodiment in connection with creating and managing the data structures with the techniques described herein; and

FIG. 6 is an example of requests, responses and events that may be included in a communication protocol between the media controller and media processor in connection with the techniques described herein.

### DETAILED DESCRIPTION

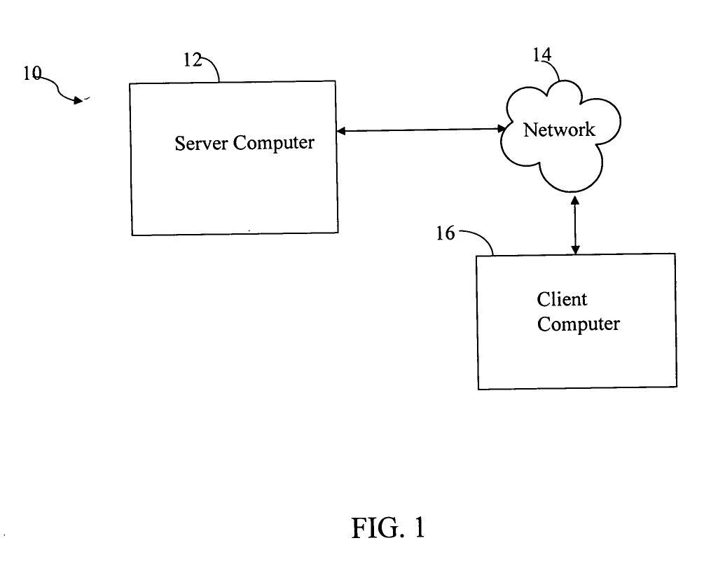

Referring now to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a server computer 12, a client computer 16, and a network 14. The server computer 12 and the client computer 16 may include a standard, commercially-available computer or a special-purpose computer that may be used to execute one or more program modules. Described in more detail elsewhere herein are program modules that may be executed by the server computer 12 in connection with facilitating the media processing operations using the techniques described herein. The server computer 12 and the client computer 16 may operate in a networked environment and communicate with other computers not shown in FIG. 1.

It will be appreciated by those skilled in the art that although the server computer and client computer are shown in the example as communicating in a networked environment, the computers may communicate with other components utilizing different communication mediums. For example, the server computer 12 may communicate with one or more components utilizing a network connection, and/or other type of link known in the art including, but not limited to, the Internet, an intranet, or other wireless and/or hardwired connection(s).

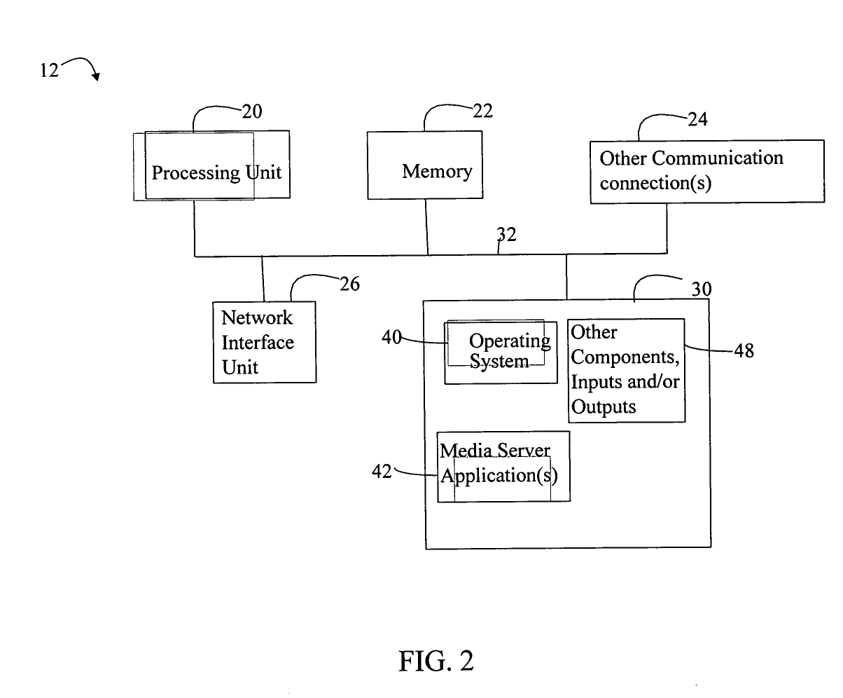

Referring now to FIG. 2, shown is an example of components that may be included in a server computer 12 as may be used in connection with performing the various embodiments of the techniques described herein. The server computer 12 may include one or more processing units 20, memory 22, a network interface unit 26, storage 30, one or more other communication connections 24, and a system bus 32 used to facilitate communications between the components of the computer 12.

Depending on the configuration and type of server computer 12, memory 22 may be volatile (such as RAM), non-volatile (such as ROM, flash memory, etc.) or some combination of the two. Additionally, the server computer 12 may also have additional features/functionality. For example, the server computer 12 may also include additional storage (removable and/or non-removable) including, but not limited to, USB devices, magnetic or optical disks, or tape. Such additional storage is illustrated in FIG. 2 by storage 30. The storage 30 of FIG. 2 may include one or more removable and non-removable storage devices having associated computer-readable media that may be utilized by the server computer 12. The storage 30 in one embodiment may be a mass-storage device with associated computer-readable media providing non-volatile storage for the server computer 12. Although the description of computer-readable media as illustrated in this example may refer to a mass storage device, such as a hard disk or CD-ROM drive, it will be appreciated by those skilled in the art that the computer-readable media can be any available media that can be accessed by the server computer 12.

By way of example, and not limitation, computer readable media may comprise computer storage media and communication media. Memory 22, as well as storage 30, are examples of computer storage media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by server computer 12. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The server computer 12 may also contain communications connection(s) 24 that allow the server computer to communicate with other devices and components such as, by way of example, input devices and output devices. Input devices may include, for example, a keyboard, mouse, pen, voice input device, touch input device, etc. Output device(s) may include, for example, a display, speakers, printer, and the like. These and other devices are well known in the art and need not be discussed at length here. The one or more communications connection(s) 24 are an example of communication media.

In one embodiment, the server computer 12 may operate in a networked environment as illustrated in FIG. 1 using logical connections to remote computers through a network. The server computer 12 may connect to the network 14 of FIG. 1 through a network interface unit 26 connected to bus 32. The network interface unit 26 may also be utilized in connection with other types of networks and/or remote systems and components.

One or more program modules and/or data files may be included in storage 30. During operation of the server computer 12, one or more of these elements included in the storage 30 may also reside in a portion of memory 22, such as, for example, RAM for controlling the operation of the server computer 12. The example of FIG. 2 illustrates various components including an operating system 40, one or more media server applications 42, and other components, inputs, and/or outputs 48. The operating system 40 may be any one of a variety of commercially available or proprietary operating system. The operating system 40, for example, may be loaded into memory in connection with controlling operation of the server computer. One or more media server applications 42 may execute in the server computer 12 in connection with performing server tasks and operations for servicing requests received from one or more client computers 16. The server computer 12 may also include other components, inputs and/or outputs 48 as may vary in accordance with an embodiment.

The media server application 42 may be used in connection with providing various services in connection with one or more types of media. For example, the media server application 42 may be used in connection with providing audio and/or video conferencing services, media relay services, gateways, and the like. The server 12 may include a multipoint control unit (MCU) with one or more media server applications thereon. The MCU may be used to establish conference calls between multiple participants for converged voice, video and/or data conferences. An MCU can provide audio-only services or any combination of audio, video and data, depending on the capabilities of each participant's terminal and the functionality of the particular MCU's hardware and/or software. It should be noted that the techniques described herein may be used in connection with other media application servers such as, for example, media relay servers.

As will be described in more detail in following paragraphs in connection with the techniques described herein, a media server application may be partitioned into two basic components, a media controller (MC) and a media processor (MP), with an abstraction layer between these components to facilitate communication therebetween. The MC performs signaling and control processing and provides instructions to the MP to perform media processing operations. The MC may be characterized as that portion of the media server application which is customized or tailored for the particular application. The processing performed by the MP may be characterized as a common set of operations for processing and serving the media to a requestor independent of the particular application and logic performed by the MC component. For example, the MP component may perform all operations for sending and receiving a media stream in connection with the particular application. The MC may issue commands for controlling operation of the media streams using the abstraction layer. Also using the abstraction layer, the MP may respond to the MC with response messages and also report any occurrences of asynchronous events to the MC. In one embodiment, the abstraction layer may be implemented using an API (Application Programming Interface) and a protocol which is described in more detail herein.

It should be noted that the client computer 16 may also include hardware and/or software components as illustrated in connection with FIG. 2. In connection with performing media processing operations, an embodiment of the client computer may include one or more client applications. For example, if the media server application 42 is included in a server computer and used in connection with providing audio and/or video conferencing services, a client computer may include a corresponding client application for the audio and/or video conferencing services.

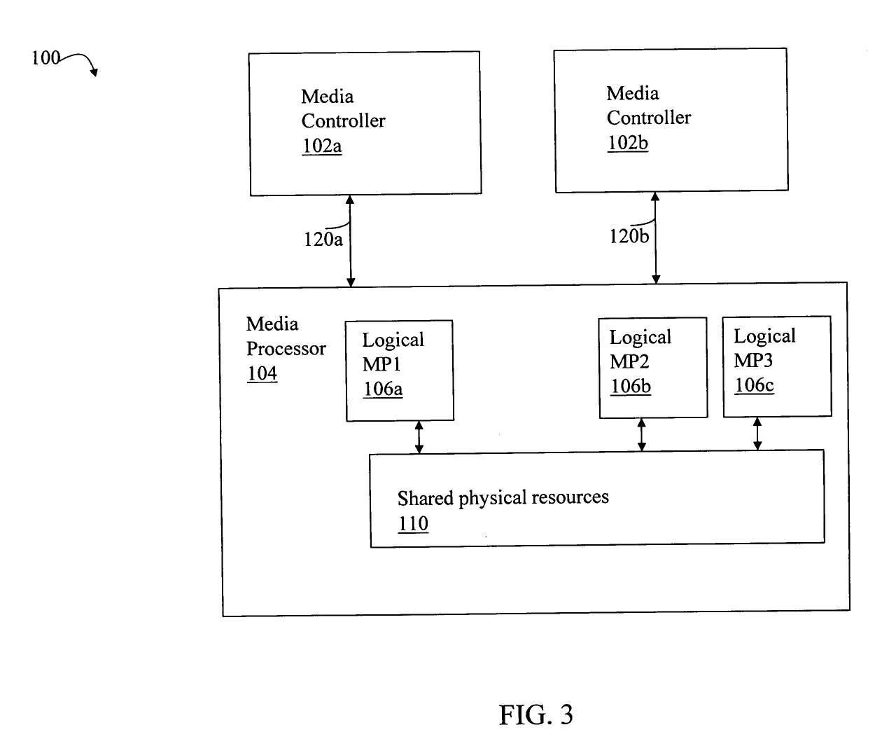

Referring now to FIG. 3, shown is an example illustrating in more detail components that may be included in connection with one or more media server applications. The example 100 includes media controllers (MCs) 102a and 102b and a media processor (MP) 104. Each of the MCs 102a and 102b may perform processing for a particular media service. Each of the MCs in this example may use the same MP component 104 in connection with performing media processing operations under the control of the respective MC. In the embodiment described herein, the MP 104 may be characterized as a logical MP constructor in which one or more instances of an MP object, or a logical MP, may be created and used in connection with servicing an MC. Each of the MCs may be associated with a different media server application. A first media server application may include MC 102a and a second different media server application may include MC 102b. As will be described in more detail, each of the first and second media server applications may utilize functionality of the MP 104.

Each of the MCs may interface with clients, for example, indirectly utilizing a conference control protocol, directly or indirectly using SIP (Session Interface Protocol), a 1^{st} party call control protocol, and the like. The MP may also communicate with clients using various protocols such as, for example, RTP (Real-time Transport Protocol)/RTCP (Real-time Control Protocol). The MP may also interface as a client with media relay servers, for example, using protocols such as STUN (Simple Traversal of UDP through NAT (Network Address Translation)) and TURN (Traversal Using Relay NAT). The abstraction layer, as described in more detail herein, resides in the MCs 102a and 102b and the MP 104. Each of the MCs 102a and 102b communicate with the MP 104 using a communication connection. In this example, MC 102a may communicate with the MP 104 over 120a and MC 102b may communicate with MP 104 over 120b.

In an embodiment, each of the MCs and/or MP may reside on the same or a different computer system and may communicate using the techniques described herein. In one embodiment in which all of the MCs and the MP resides on the same system, the MC and MP may communicate using API functions and call backs.

As mentioned above, the MP 104 may be used in constructing one or more logical MPs 106a, 106b and 106c. It should be noted that although a number of MCs and logical MPs are included in FIG. 3, the particular number of each is merely illustrative. An embodiment may include one or more MCs and one or more logical MPs.

A logical MP may service a single MC. An instance of a logical MP may be constructed and utilized by the single MC. The single MC may create and be serviced by one or more logical MPs. For example, with reference to FIG. 3, MC 102a may create and be serviced by MP1 106a. MC 102b may create and be serviced by MP2 106b and MP3 106c. As illustrated in the example 100, multiple logical MPs may reside on a single platform and share physical system resources. Using the techniques described herein, a single MC may construct multiple logical MPs, each for various media procession operations. Each logical MP has a unique identifier, generated by the MP 104, which exists until the logical MP is destructed by the MC which created the logical MP. It should be noted as used herein, “destruction” of an element refers to deallocation or freeing associated resources for reuse within the MP.

An MC, such as MC 102a, may issue control and signal commands to the one or more logical MPs, such as logical MP 106a, associated with that particular MC. A logical MP may perform common operations such as mixing multiple audio streams to generate a combined audio stream based on control commands issued by an MC. The logical MPs may also perform encoding and/or decoding operations as instructed by the MC.

As an example with audio conferencing with three participants, in one arrangement, an MC may provide an initial trigger by sending a JOIN or INVITATION message to each of the participants at a scheduled time. Each of the participants may have a client computer connected to the server computer. Each participant may respond with a message from his/her client computer to the MC indicating they will join the conference. The MC may then utilize the techniques described herein to output the appropriate media stream to each of the participants. The MP may combine or mix the incoming audio streams and generate an output stream as appropriate for each participant. Additionally, during the conference, commands may be issued to the server from one or more client computers. For example, a conference may have a few presenters and many passive listeners. The techniques described herein may be used to exclude from a generated audio output stream any input stream from a passive listener, and also include in the generated audio output stream the input stream from only the currently active speaker. During the conference, the active presenter may change and the techniques described herein may be used to appropriately allow the logical MP to notify the MC of the change in active speaker, and have the MC respond by issuing commands to the logical MP servicing the MC to accordingly modify the generated combined output stream to the conference participants.

What will now be described are the structures created and used in connection with the techniques described herein. Reference may be made to particular examples or uses for purposes of illustration of the techniques described herein and should not be construed as a limitation regarding the applicability of these techniques.

Once the MC has received a reply from one or more of the participants, a context structure may be defined. A context may be defined for each set of one or more input streams (e.g., audio and/or video) that interact with each other. In connection with a conferencing example, a first context may be defined for a main conference between all participants. A second context may be defined for a side conference between only two participants who wish to have a side conference while the main conference is going on.

A termination structure may be defined for each of the logical communication endpoints. As described herein with one example, an endpoint may be, for example a single client application on a client computer. The termination structure associates multiple streams that are sent to/received from the same logical endpoint. Such a logical endpoint may also be referred to herein as a termination associated with a termination structure. In one embodiment, all streams that are output and sent to the same termination are synchronized. A logical endpoint or termination may also be, for example, another MC. Referring back to the audio conference example, a single termination structure may be created for each client application on the client computer of each conference participant.

A stream structure may be defined for each single media (e.g., audio, video) that is sent to/received from a single termination. A stream can be full duplex (sent and received) or half duplex (sent or received) or inactive. For each stream, multiple descriptors may be defined. In one embodiment, the following descriptors may be associated with each stream: a local descriptor, a remote descriptor, an ingress (incoming) filter descriptor, and an egress (outgoing) filter descriptor. Collectively, the descriptors associated with a stream may be used to describe the various attributes of the incoming and outgoing streams and how the stream interacts with any other streams of the same context. Referring to the audio conference example, a single stream structure may be defined and associated with the audio stream for each conference participant.

A local descriptor defines the attributes of the ingress stream (e.g., stream received from the endpoint). The local descriptor describes the MP environment or side of the communication. The local descriptor may include, for example, encoding and decoding parameters, transport parameters, port address, transmission speed, and the like.

A remote descriptor defines the attributes of the egress stream (e.g., stream sent to the endpoint). The remote descriptor describes the remote side or the endpoint location. The remote descriptor may include parameters similar to that as described above for the local descriptor except that the parameters apply to the endpoint or termination. If the endpoint represents a file, for example, used for archiving, then the remote descriptor may include the file name and how to access the file.

An ingress filter descriptor defines what terminations receive the associated stream. In one embodiment, the ingress filter descriptor may be optional. If an ingress filter is not specified, then a default behavior may be defined. In one embodiment the default behavior may be that all terminations in the context receive the associated stream. The ingress filter enables muting an ingress stream from all other terminations or particular terminations. For example, in large conferences with only a few presenters and many passive listeners, ingress filters may be used to block ingress streams for all passive listeners and block/open the active presenter as needed. As another example, in an audio conference call, if a participant mutes his/her voice resulting in a command to the MC, the MC may in turn cause the ingress filter descriptor associated with the participant to be accordingly updated.

An egress filter descriptor defines what terminations are selected as ingress streams (source media) for the egress stream of this termination. In addition it defines what media processing, such as switch or mix, may be used. In one embodiment, the egress filter descriptor may be optional. If the egress filter for a stream is not defined, a default behavior may be specified. In one embodiment, the default behavior may be that all terminations in the context are selected, except the stream's own termination (e.g., no loop). In addition, a default media processing option may be defined in accordance with the particular media. For example, a default media processing for voice is mixing and for video is switching, based on active speaker. If active speaker does not contribute any video, then the previous speaker may be selected.

It should be noted that communications over 120 and 120b between the MP 104 and each MC may be two-way communication connections. As described in more detail herein, commands may be sent from the MC to the MP 104 in accordance with a defined messaging protocol and API. The MP 104, or logical MP included therein, may respond to the MC with response messages. The messages originating from the MC may be commands or control messages to manage the structures and descriptors such as, for example, to create a context, modify an existing context or element associated with an existing context. The commands sent from the MC to the MP 104 may be in response to the MC receiving an external message, such as from a conference participant making a modification to an option, a new participant joining an existing conference, and the like. Additionally, the MP 104, or logica MP included therein, may originate messages in the form of asynchronous event reporting to the MC such as, for example, regarding the currently active speaker. This is also described in more detail herein.

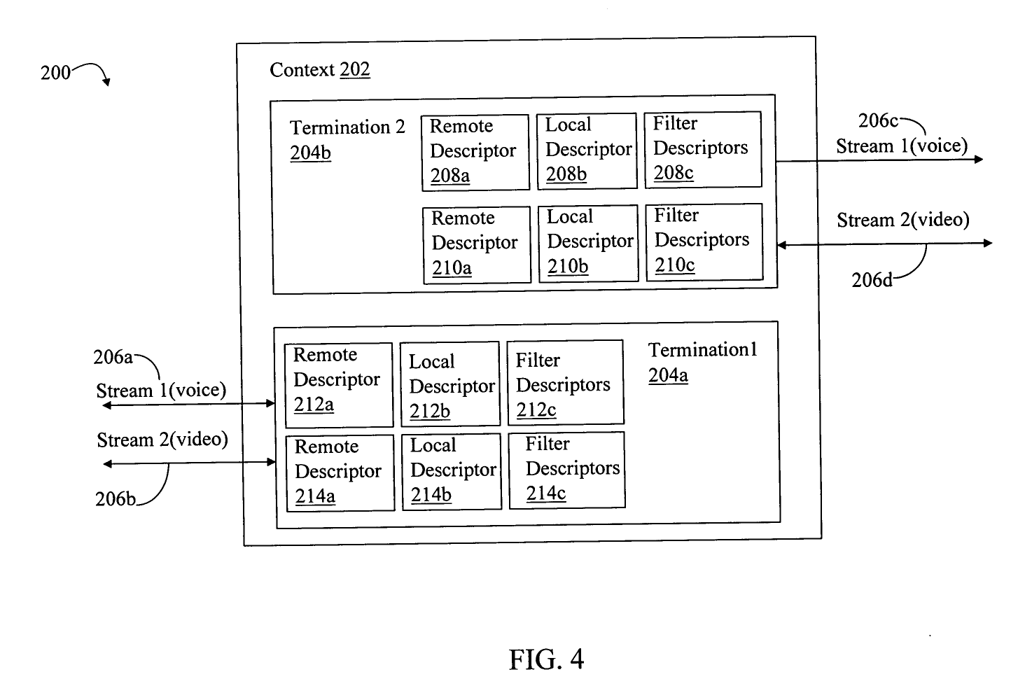

Referring now to FIG. 4, shown is an example illustrating the different structures defined in connection with the techniques described herein. The example 200 illustrates the different structures and descriptors just described for a context. The example 200 includes a context 202 having two terminations described by 204a and 204b. Termination 1204a is associated with two streams—stream 1206a and stream2 206b. Element 206a represents a voice or audio stream and element 206b represents a video stream. Stream 1 206a has corresponding descriptors 212a, 212b and 212c. It should be noted that elements 212c and 214c represent the ingress and outgress filters for each associated stream. Stream 2 206b has corresponding descriptors 214a, 214b, and 214c. Termination 2 204b is associated with two streams—stream 1206c and stream 2 206d. Element 206c represents a voice or audio stream and element 206d represents a video stream. Stream 1206c has corresponding descriptors 208a, 208b and 208c. It should be noted that elements 208c and 210c represent the ingress and outgress filters for each associated stream. Stream 2 206d has corresponding descriptors 210a, 210b, and 210c. Each of streams 206a, 206b and 206d are bidirectional/duplex, and stream 206c is half duplex for sending/outgoing from the server.

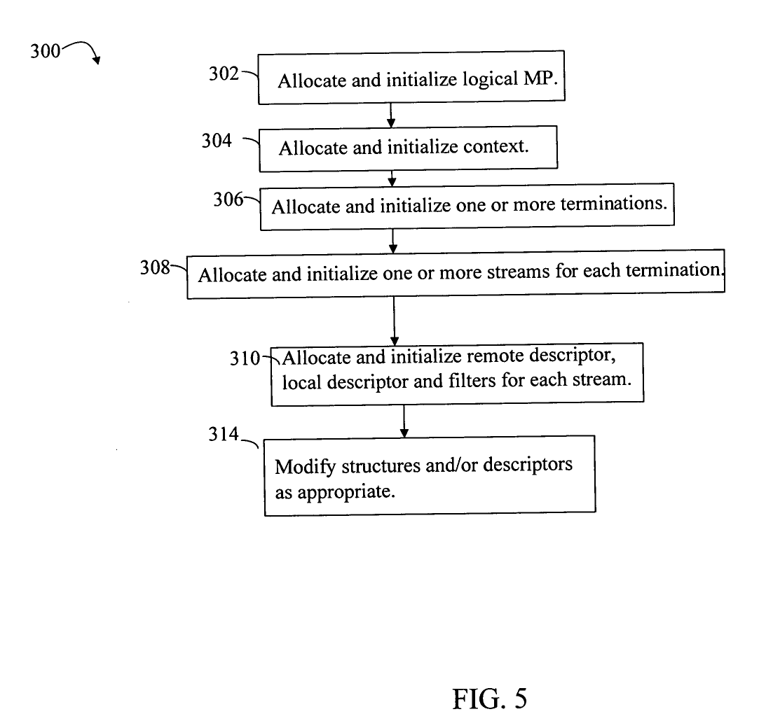

Referring now to FIG. 5, shown is a flowchart of processing steps that may be performed in an embodiment in connection with the techniques described herein. The flowchart 300 summarizes processing steps performed by the MC and the MP 104 in connection with management of the structures and descriptors herein. It should be noted that a protocol that may be used in connection with performing the steps of flowchart 300 is described elsewhere herein in more detail. At step 302, a logical MP is allocated and initialized. It should be noted that one or more logical MPs may be created for particular media processing operations as described herein and a particular logical MP may be used as determined by an MC. The one or more logical MPs may be defined as part of setup or initialization processing in an embodiment of the server computer. At step 304, a context is allocated and initialized. Step 304 may be performed, for example, in response to a request to arrange an audio conference. At step 306 one or more termination structures are allocated and initialized. At step 306, a termination structure may be defined for each endpoint or termination, such as each conference participant. At step 308, one or more stream structures are allocated and initialized for each termination. A stream structure may be defined for each media, such as audio or video. At step 310, the various descriptors for each stream may be allocated and initialized. Step 310 may include defining the remote descriptor, local descriptor, and ingress (incoming media stream) and egress (outgoing media stream) filters as described herein. At step 314, the structures and/or descriptors may be accordingly modified for the current context as needed during the lifetime of the current context. For example, a mute enable or disable for a particular stream by a conference participant may cause an update to the structures. It should be noted that step 314 may also result in the creation of additional structures, for example, with the addition of a new conference participant. At any point in time for an existing context, the logical MP generates output streams in accordance with the structures and descriptors of the context. The MC may transmit commands to the logical MP to update the structures as needed in accordance with external commands received at the server computer as well as in response to certain events reported to the MC by the logical MP.

What will now be described is an example of an MC-MP communication protocol. It should be noted that the MC may utilize the protocol communicate directly with the particular logical MP in connection with command requests. In connection with this protocol, the MC sends requests to the MP 104, and the MP 104 sends response messages to the MC. The MP 104 also report on particular events to the MC in an asynchronous fashion. If a request from the MC to the MP 104 fails, the MP 104 returns the structures and descriptors to the state that existed prior to execution of the request. As will be described herein, the protocol may include messages directed to the MP component 104 as well as to a particular logical MP. Similarly, the protocol may include messages sent from the MP component 104 to the MC as well as from a logical MP to the MC. In one embodiment, messages exchanged between the MC and the MP 104, or logical MP, may be XML messages although other message formats may be used. It should be noted that a more detailed XML schema that may be used is included in following paragraphs.

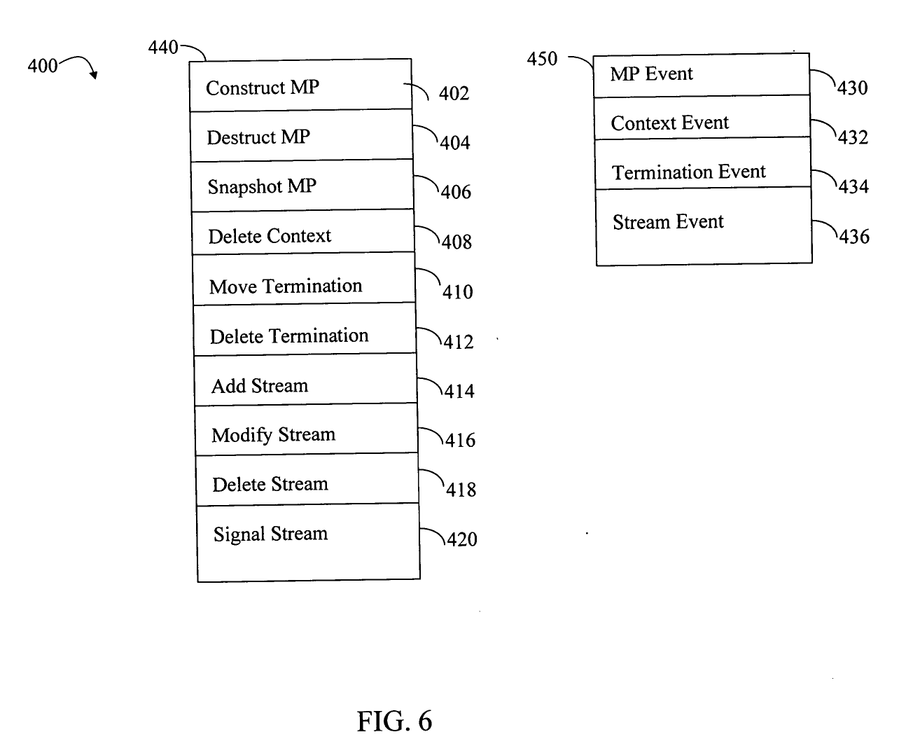

Referring now to FIG. 6, shown is an example of the types of communications that may be exchanged between the MP 104, or logical MP therein, and the MC in accordance with one protocol. The table 440 includes the messages that may be sent from the MC to the MP 104, or logical MP therein. In one embodiment described herein, all of the message types in the table 440 with the exception of types 402 and 404 may directed to particular logical MPs. The table 450 includes the types of messages that may be originated by the MP side (e.g., MP 104 or logical MP), such as a particular logical MP included therein, and sent to the MC in connection with event notification. For each message included in table 440, the MP side may also send a corresponding reply or response message to the MC. The table 440 includes the following request types that may be initiated by the MC and sent to the MP side: construct MP 402, destruct MP 404, snapshot MP 406, delete context 408, move termination 410, delete termination 412, add stream 414, modify stream 416, delete stream 418, and signal stream 420. Table 450 includes the following types of event notification messages that may be initiated by the MP and sent to the MC: MP event 430, context event 432, termination event 434 and stream event 436.

A construct MP request 402 initiates an instance of a logical MP based on a description that is included in the request. The information may identify, for example, the type of service to be performed by the logical MP instance being created. An example of a construct MP request 402 may be:

```
< request requestId=”1” from=”mc1” to=”mp1”>
  <constructMP>
    < mp-description>
      <services>switchMix</services>
      .... optional data
    </mp-description >
  </constructMP>
</request>
```

As a result, the MP 104 instantiates and instance of a logical MP. The MP 104 sends a response back to the requesting MC that includes logical MP identifier. An example of such a response message may be:

```
<response requestId=”1” from=”mc1” to=”mp1” code=”success”>
  <constructMP>
    <mp-type>
      <mp-keys>
        <mpEntity>mp1.1</mpEntity>
      </mp-keys>
      ... optional data
    </mp-type>
  </constructMP>
</response>
```

A destruct MP request 404 destructs or deallocates an active logical MP. Such a request may be sent from the MC to the MP 104 to free resources. As previously described, a “destruction” of a logical MP, or other element includes deallocation of associated resources for reuse. An example of a request message 404 may be:

```
<request requestId=”1” from=”mc1” to=”mp1”>
  <destructMP>
    <mp-keys>
      <mpEntity>mp1.1</mpEntity>
    </mp-keys>
  </destructMP>
</request>
```

As a result the MP destructs and frees the resources of logical MP mp1.1 in the example. The MP returns a response to the MC with the logical MP information that shows the status of the logical MP before the request. Such information may include statistics for the duration of the lifetime of the logical MP. Examples of statistics that may be obtained in an embodiment may include, for example, the number of contexts, statistics about each context such as maximum and average number of terminations, maximum and average bandwidth, and the like. An example of a response message sent from the MP to the MC in response to a request of type 404 may be:

```
<response requestId=”1” from=”mc1” to=”mp1” code=”success”>
  <destructMP>
    <mp-type>
      <mp-keys>
        <mpEntity>mp1.1</mpEntity>
      </mp-keys>
      ... optional data
    </mp-type>
  </destructMP>
</response>
```

A snapshot MP request 406 returns the current status of a logical MP. The response includes a detailed description of state and usage of resources. The snapshot may include, for example, current values for one or more of the statistics described in connection with message type 404. An example of a message of type 406 may be:

```
<request requestId=”1” from=”mc1” to=”mp1”>
  <snapshotMP>
    <mp-keys>
      <mpEntity>mp1.1</mpEntity>
    </mp-keys>
  </snapshotMP>
</request>
```

As a result the logical MP returns a response with MP logical data that shows the current status of the requested logical MP. An example of a response message of type 406 may be:

```
<response requestId=”1” from=”mc1” to=”mp1” code=”success”>
  <snapshotMP>
    <mp-type>
      <mp-keys>
        <mpEntity>mp1.1</mpEntity>
      </mp-keys>
      ... optional data
    </mp-type>
  </snapshotMP>
</response>
```

A delete context request 408 deletes a context with all its terminations and streams. In one embodiment, a context may be deleted implicitly when the last stream in the context is deleted. Accordingly, in normal operation, a request of type 408 may not be used. An embodiment of the MC may use this request, for example, when there is an immediate need to abort a context. As an example, delete context may be the result of a command from a conference organizer such as when the organizer leaves the conference and does not want the other participants to continue using currently allocated resources for the conference. An example of a request of type 408 may be:

```
<request requestId=”1” from=”mc1” to=”mp1”>
  <deleteContext>
    <context-keys>
      <mpEntity>mp1.1</mpEntity>
      <contextEntity>context1</mpEntity>
    </context-keys>
  </deleteContext>
</request>
```

In connection with this particular example, the logical MP destructs and frees the resources of context1 in logical MP mp1.1 and returns a response with information, such as statistical information, about the deleted context. Statistical information returned in an embodiment may include, for example, start time, end time, average bandwidth, lost packets, and the like. The statistical information may be used, for example, for management purposes such as when a user calls a help desk regarding the quality of a specific call. The statistical information may be used in connection with measuring different quality aspects.

It should be noted that if the context is deleted implicitly as a result of deleting a last stream in the context, the logical MP managing that context may fire a context event that includes similar information that may otherwise be returned in connection with the delete context response. An example of a response message of type 408 may be:

```
<response requestId=”1” from=”mc1” to=”mp1” code=”success”>
  <deleteContext>
      ...
  </deleteContext>
</response>
```

In one embodiment, a context may also be constructed implicitly when the first stream is added to the context, such as using the add stream request described below. The context may also be destructed implicitly when the last stream in the context is deleted, such as using the delete stream request as described below.

A move termination request 410 moves a termination from one context to another in a single operation (e.g., vs. delete and add in two steps). In one embodiment, by default a logical MP may preserve all termination attributes except the filters descriptors that by default may be removed. The MC may overwrite termination parameters, including filters, in the move termination command. These changes may be applied immediately after the termination is moved to the new context. As an example, a participant of a conference may move from one conference to another and a move termination request may be used to reflect this conference move. The move command may be characterized as a compound command to delete and add a termination in a single request in an atomic operation. An example of a request of type 410 may be:

```
<request requestId=”1” from=”mc1” to=”mp1”>
  <moveTermination>
    <termination>
      <termination-keys>
        <mpEntity>mp1.1</mpEntity>
        <contextEntity>context1</mpEntity>
        <terminationEntity>termination1</terminationEntity>
      </termination-keys>
    <streams>
      ...
    </streams>
  </termination>
  <destination-context-keys>
        <mpEntity>mp1.1</mpEntity>
        <contextEntity>context2</mpEntity>
    </destination-context-keys>
  </moveTermination>
</request>
```

As a result in connection the foregoing example request, the logical MP deletes the termination from context1 and adds it to context2. Streams fields in this example request form may be optional and used to modify streams descriptors if needed. By default, filters are removed. Therefore if the streams field is not included in the request, the new termination is connected by default to all other terminations in context2 based on any existing default rules. Upon completion the logical MP sends back a response that includes termination status before the termination has been removed. As mentioned above, this command may be characterized as a compound command for performing a delete and add operation. In one embodiment, the statistics returned may be similar to those returned in connection with a delete termination as described elsewhere herein. Below is an example of a response message of type 410:

```
<response requestId=”1” from=”mc1” to=”mp1” code=”success”>
  <moveTermination>
    <termination>
      <termination-keys>
        <mpEntity>mp1.1</mpEntity>
        <contextEntity>context1</mpEntity>
        <terminationEntity>termination1</terminationEntity>
      </termination-keys>
      <streams>
      ...
      </streams>
    </termination>
  </moveTermination>
</response>
```

A delete termination request 412 sent from the MC to a logical MP deletes a termination with all its streams. In normal operation processing, a context may be deleted implicitly when the last stream in the termination is deleted. The MC may use this request type when it needs to abnormally abort a termination. Such a circumstance may occur, for example, when a user leaves a conference or is otherwise ejected from a conference. An example of a request of type 412 may be:

```
<request requestId=”1” from=”mc1” to=”mp1”>
  <deleteTermination>
    <termination-keys>
      <mpEntity>mp1.1</mpEntity>
      <contextEntity>context1</mpEntity>
      <terminationEntity>termination1</terminationEntity>
    </termination-keys>
  </deleteTermination>
</request>
```

As a result in connection with foregoing example request, the logical MP deletes termination1 from context1 in mp1.1, including all the streams of termination1, and sends back a response that includes information such as, for example, various statistics. Examples of such statistics may include statistics about a particular user such as start time, end time, bandwidth, errors, and the like. Such statistical information may be used, for example, to evaluate the connection for a particular user in a conference in connection with quality of service determination. If the termination is the last termination in the context then the context is deleted as well and a context event is fired to the MC that includes context statistics. An example of a response message of type 412 sent from the logical MP to the MC may be:

```
<response requestId=”1” from=”mc1” to=”mp1” code=”success”>
  <deleteTermination>
  <termination>
      <termination-keys>
        <mpEntity>mp1.1</mpEntity>
        <contextEntity>context1</mpEntity>
        <terminationEntity>termination1</terminationEntity>
      </termination-keys>
    <streams>
      ...
    </streams>
    </termination>
  </deleteTermination>
</response>
```

An add stream request 414 adds a stream to an existing termination and/or context. As described below, this request may also result in creation of a new context and/or termination. If the termination key is set to ‘choose’, (e.g., by setting the value to ‘*’), then the logical MP creates a new termination and returns its value to the MC in the add stream response. Similarly, a new context may be created in connection with the add stream request and a pointer or identifier for the newly created context returned in the corresponding response. An add stream request 414 may include a remote descriptor (e.g., egress stream to remote endpoint), a local descriptor (e.g., ingress stream from endpoint) without transport address parameters, may also include filter descriptors. The transport address of local descriptor is generated by the logical MP and returned to the MC via the add stream response.

An example of a request of type 414 may be:

```
<request requestId=”1” from=”mc1” to=”mp1”>
  <addStream>
    <stream>
      <streams-keys>
        <mpEntity>mp1.1</mpEntity>
        <contextEntity>*</mpEntity>
        <terminationEntity>*</terminationEntity>
        <streamEntity>voice-type-1</streamEntity>
      </streams-keys>
      <display-text>alice</display-text>
        <local-description>
        ...
        </local-description>
        <remote-description>
        ...
        </remote-description>
    </stream>
  </addStream>
</request>
```

In the foregoing, note that the attribute ‘Display Text’ may be used to define what text, (using bitmap), may be displayed inside a video window of a display, such as user's name. As a result of the foregoing example request, the logical MP constructs a new context and termination and adds the stream to the termination. The logical MP assigns identifiers to the new context and termination and accordingly returns the values in the response. An example of a response of type 414 may be:

```
<response requestId=”1” from=”mc1” to=”mp1” code=”success”>
  <addStream>
    <stream>
      <stream-keys>
        <mpEntity>mp1.1</mpEntity>
        <contextEntity>context1</mpEntity>
        <terminationEntity>termination1</terminationEntity>
        <streamEntity>voice-type-1</terminationEntity>
      </stream-keys>
        <local-description>
        ...
        </local-description>
    </stream>
  </addStream>
</response>
```

Each context has a global unique identifier within a logical MP, which may be assigned by the logical MP in connection with the first add stream request with Context ID (e.g., associated with contextEntity in the previous example) set to ‘*’, (e.g., which means choose), and received by the MC via an add stream response. The MC may add more streams to the same context by setting a specific Context ID in an add stream request.

A modify stream request 416 may be used to modify stream attributes. The request and response format may be as described in connection with add stream requests and responses with the modification that stream-keys and local descriptor are specified in the request by the MC in order to specify the modifications to the stream.

It should be noted that each stream has a unique stream identifier within a logical MP. By default all streams within a context that share the same stream ID interact with each other, for example mixed or switched. The default behavior can be changed by setting filter descriptors (for details see filter descriptors below). The default behavior may be modified in accordance with the particular media such as, for example, mix stream with all other streams associated with the same source/destination, or switch based on active speaker. The ingress and egress filter descriptors may be used to indicate such changes.

A delete stream request 418 deletes a stream from a termination. If the stream is the last stream in the termination, then the termination may be implicitly deleted as well. If the termination is the last termination in the context then the context may be implicitly deleted as well. An example of a request of type 418 may be:

```
<request requestId=”1” from=”mc1” to=”mp1”>
  <deleteStream>
      <streams-keys>
        <mpEntity>mp1.1</mpEntity>
        <contextEntity>context1</mpEntity>
        <terminationEntity>termination1</terminationEntity>
        <streamEntity>voice-type-1</streamEntity>
      </streams-keys>
    </stream-keys>
    </deleteStream>
</request>
```

As a result of the foregoing example request, the logical MP “mp1.1” deletes stream “voice-type-1” from termination1/context1/mp1.1 and sends back to the MC a response that includes information about the deleted stream. Such information may include statistics. In an embodiment, the information may include statistics about a specific stream such as audio or video. Such statistics may include, for example, bandwidth, error type and number of errors, and the like. If the stream is the last stream in the termination, then the termination “termination1” is deleted as well. In addition if “termination1” is the last termination in the context “context1”, then the context “context1” is deleted as well. An example of a response of type 418 may be:

```
<response requestId=”1” from=”mc1” to=”mp1” code=”success”>
  <deleteStream>
    <stream>
      <stream-keys>
        <mpEntity>mp1.1</mpEntity>
        <contextEntity>context1</mpEntity>
        <terminationEntity>termination1</terminationEntity>
        <streamEntity>voice-type-1</streamEntity>
      </stream-keys>
      ...
      </stream>
  </deleteStream>
</response>
```

A signal stream request 420 sends a signal to a selected list of streams in a context. The particular defined signals in an embodiment may vary. For example, in one embodiment, the types of defined signals are announcements, and sequence of DTMF (Dual Tone Multi Frequency). A sequence of DTMF may represent, for example a PIN number dialed from a keypad. The foregoing is an example of a request of type 420:

```
<request requestId=”1” from=”mc1” to=”mp1”>
  <signalStream>
    <streamSelect>
        <all>true</all>
      </streamSelect>
        <announcement>
          <name> welcome</name>
          <modify-when-done>false</modify-when-done>
        </announcement>
    </signalStream>
</request>
```

As a result of the foregoing example request, the logical MP sends an announcement to all the streams in the context, regardless of the media state (e.g., even streams having states of inactive and send have the announcement sent). The announcement may be mixed with any egress media if in the process of being transmitted. The logical MP sends a response to the MC without waiting for the announcement to be played. An example of a response of type 420 may be:

```
<response requestId=”1” from=”mc1” to=”mp1” code=”success”>
  <signalStream>
    ...
  </signalStream>
</response>
```

In this example, of the modify-when-done field has a value set to true in the request, then the logical MP also sends a stream event indicating the announcement is done after the announcement is played. An announcement may be triggered, for example, in response to the MC receiving an external message from a conference participant such as conference leader which is to be communicated to all participants.

In connection with events occurring in the MP side, each of the logical MPs may report events asynchronously to the MC. The particular events that may be reported to the MC may vary with embodiment. In one embodiment, an MP event notification message may be sent to the MC when a logical MP is out of service or almost out of service. An “out of service” state may occur, for example, due to an inability to add contexts, terminations and/or streams because of lack of additional resource utilization. Upon receiving an indication of such an event, the MC may perform processing to reject any subsequently received commands requiring such additional resources, or otherwise use a different logical MP if available. A context event notification message may be sent to the MC upon the occurrence of a context event. One example of a context event is when the currently active speaker in a context changes. In response to receiving such a notification, the MC may send a notification to conference participants, for example, using a conference control protocol as known in the art.

A termination event notification message may be sent to the MC upon the occurrence of a defined termination event. As an example, an endpoint may be associated with a phone and a conference participant may press a phone button which is reported to the MC using the termination event notification message.

A stream event notification message may be sent to the MC upon the occurrence of a stream event. An example of a stream event which may be reported to the MC may be an announcement done event. As described above in connection with a signal stream, an announcement may be sent to all streams in a context. Once the announcement has been played, a stream event notification message may be sent to the MC.

Using the foregoing protocol, different structures and descriptors may be implicitly constructed and/or destructed although an embodiment may also include explicit construction and/or destruction operations as well. In one embodiment using the foregoing protocol, a context may be constructed implicitly when the first stream is added to the context, for example, using the add stream request. The context may be destructed implicitly when the last stream in the context is deleted, for example, using delete stream request. The MC can destruct explicitly a context at any time, for example, using the delete context request, which automatically destructs all the objects within the context. A termination may be constructed implicitly when the first stream is added to the termination, such as using the add stream request. The termination may be destructed implicitly when the last stream is deleted from the termination, for example, using the delete stream request. The MC can destruct explicitly a termination at any time, for example, using the delete termination request, which automatically destructs all the objects within the termination. In addition the MC can move a termination to another context, for example, using the move termination request which may be characterized as a compound request that alternatively can be done in two steps by using delete and add termination requests. A stream may be constructed explicitly, for example, using the add stream request and may be destructed explicitly, for example, using the delete stream request. All streams in a termination may be destructed implicitly when the termination or context to which they belong is destructed.

Referring back to FIG. 5, the processing steps of flowchart 300 may be performed in accordance with the protocol illustrated in FIG. 6. For example, creation of the logical MP may be performed by the MC issuing a construct MP request to the MP 104. The various structures and descriptors may be populated by the MC and/or MP 104 at various times depending on when the information is known. For example, some information may be known at the time an MC requests creation of a structure or descriptor. As such, the MC may pass such information to the MP 104 when such a request is issued.

Using the techniques described herein, a server computer may use a second MC for failover purposes in the event a primary MC experiences a failure. For example, a first or primary MC may be on a first system included in the server 12. A second or failover MC may be on a second system included in the server 12. The MP 104 may be on a third system of the server 12. In the event that the primary MC fails, the second MC may handle servicing of requests rather than the primary MC. The particular state information about the logical MPs may be communicated to the second MC, for example, using the snapshot MP request. The second MC may request information about the logical MPs servicing the primary MC. In one embodiment, when the second MC takes over, the second MC uses the logical MPs that were serviced by the primary MC. Information regarding the particular logical MPs servicing the primary MC may be stored in a location available to the second MC in the event that the primary MC experiences a failure. The second MC may then use the snapshot request or other techniques known in the art as may be included in an embodiment to obtain information about the logical MPs in order to assume the role of the failed primary MC.

The techniques described herein may be used with a variety of different services. Examples used herein may include conferencing and a server providing services as a communication gateway, for example, in which the MC issues commands to a logical MP to convert one or more input streams from one client into a form usable by a second different client. Following is an example of an XML schema that may be used in connection with the example message formats described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing media services comprising:
providing a media processor that receives one or more input media streams and provides an output media stream to one or more endpoints; and
providing a media controller that issues commands to said media processor for controlling said media streams, wherein said media controller and said media processor communicate in accordance with a defined protocol allowing for independent control of each of said media streams.

2. The method of claim 1, wherein said media streams include one or more of audio, video and data.

3. The method of claim 1, further comprising:
said media controller issuing commands to said media processor in accordance with said defined protocol to allocate a plurality of structures and descriptors used in connection with providing media services.

4. The method of claim 3, wherein a context structure is defined for each set of one or more input streams that interact with each other.

5. The method of claim 4, wherein a termination structure is defined for each endpoint associated with said context structure.

6. The method of claim 5, wherein a stream structure is defined for each single media type sent to or received from each endpoint.

7. The method of claim 6, wherein each stream structure is associated with a plurality of descriptors including a local descriptor describing communication attributes at said media processor, and a remote descriptor describing communication attributes at an endpoint associated with said stream structure.

8. The method of claim 7, wherein said plurality of descriptors includes one or more of: an ingress filter descriptor defining what endpoints associated with said context structure receive a media stream for a single media type associated with a stream structure, and an egress filter descriptor defining what endpoints are selected as source media for an outgoing stream associated with said egress filter descriptor, said egress filter descriptor defining a type of media processing to be performed.

9. The method of claim 8, wherein if said egress filter descriptor or said ingress filter descriptor is not defined, a default behavior is used in accordance with a media type of a stream represented by a stream structure associated with an undefined filter descriptor, wherein said default behavior for said egress filter descriptor is that all endpoints of a context structure are selected, and default media processing performed for a voice media type is mixing and default media processing for a video media type is switching between video input streams in accordance with a currently active speaker.

10. The method of claim 1, wherein said media processor reports events of an event type to said media controller in accordance with said defined protocol, said defined protocol including a plurality of event types including a media processor event, a context event, a termination event, and a stream event.

11. The method of claim 6, wherein said context structure is implicitly constructed when said media controller issues a command request to said media processor to construct a first stream structure associated with said context structure, and wherein said context is implicitly destructed when a last stream structure associated with said context structure is deleted using a command request to explicitly request said media processor to delete said last stream structure.

12. The method of claim 6, wherein a termination structure associated with an endpoint is implicitly constructed when a first stream structure is added for said endpoint in response to a command request from said media controller to said media processor to add said first stream structure for said endpoint.

13. The method of claim 12, wherein a termination structure is implicitly destructed when a last stream is deleted from the termination structure in response to a command request from said media controller to said media processor to delete said last stream structure.

14. The method of claim 6, wherein said protocol includes a request issued by the media controller to said media processor to move a termination structure from one context structure to another context structure.

15. The method of claim 1, further comprising:
issuing one or more command requests by said media controller to said media processor to create one or more logical media processor instances for servicing said media controller.

16. The method of claim 15, wherein a server system includes a plurality of media controllers, said plurality of media controllers including said media controller as a first media controller and a second media controller, wherein said first media controller controls operation of a first set of one or more logical media processor instances and said second media controller controls operation of a second set of one or more different logical media processor instances.

17. A server for providing media services comprising:
a media processor that receives one or more input media streams and provides an output media stream to one or more endpoints;
a media controller that issues commands to said media processor for controlling said media streams, wherein said media controller and said media processor communicate in accordance with a defined protocol; and
said defined protocol including a command request issued by said media controller to said media processor to define a logical instance of a media processor to service said media controller.

18. The server of claim 17, wherein said media controller issues a plurality of command requests to said media processor to create a plurality of logical media processor instances for servicing said media controller.

19. The server of claim 17, further including a plurality of media controllers, said plurality of media controllers including said media controller as a first media controller and a second media controller, wherein said first media controller controls operation of a first set of one or more logical media processor instances servicing said first media controller, and said second media controller controls operation of a second set of one or more different logical media processor instances for servicing said second media controller.

20. A computer readable medium comprising executable instructions stored thereon for providing media services comprising:
code that establishes a media processor that receives one or more input media streams and provides an output media stream to one or more endpoints; and
code that establishes a media controller that issues commands to said media processor for controlling said media streams, wherein said media controller and said media processor communicate in accordance with a defined protocol allowing said media controller to control each incoming and outgoing stream from each of said endpoints independently of other streams, and wherein one or more logical instances of a media processor service said media controller.
